(19) United States
(12) Patent Application Publication
(10) Pub. No.: US 2010/0244785 A1
(43) Pub. Date: Sep. 30, 2010

(54) Source Power Limiting Charging System

(75) Inventors: Bryan Theodore Silbermann, Fremont, CA (US); Thomas Joel Huber, San Francisco, CA (US)

Correspondence Address: Silicon Valley Patent Group LLP, 18805 Cox Avenue, Suite 220, Saratoga, CA, 95070, US

(73) Assignee: Applied Micro Circuits Corporation, San Diego, CA (US)

(21) Appl. No.: 12/413,505

(22) Filed: Mar. 27, 2009

(51) Int. Cl. H02J 7/00

(52) U.S. Cl. 320/166

(57) ABSTRACT

Methods and systems for charging energy storage devices are disclosed. Often the charging circuit may have different levels of power available to charge the energy storage device depending on the state of other subsystems of the electronic system. The present invention provides a source power limiting charging system. Often the losses of the charging system and losses due to the power requirements of support systems are not well known and/or are variable. Controlling source power to the charging system maximizes the amount of power delivered to the energy storage device for a given value of these losses and avoids power contention with the other elements of the electronic system. Therefore, the power drawn from the power source by a controllable power limiting charging circuit is controlled to be less than a source power limit.

### BACKGROUND

1. Background Field

The present invention relates to power charging systems for energy storage devices.

2. Relevant Background

In many electronic systems, in particular data storage systems, unexpected power failures may cause loss of data or other problems. Thus, many such electronic systems include a backup power system to provide temporary power to the electronic system during a power failure. Typically, the electronic system performs shut down operations to prevent data loss. FIG. 1 is a block diagram of an electronic system 100, having a power source 110, a functional device 120, and a conventional backup power system 130. Functional device 120 performs the main function of electronic system 100. Power source 110 provides power to functional device 120 and to backup power system 130. Backup power system 130 is configured to store energy from power source 110 and to provide power to functional device 120 in case power source 110 fails.

Backup power system 130 includes a power path control circuit 131, a charging circuit 133, an energy storage device 135, and a discharge circuit 137. When power source 110 is available, power path control circuit 131 is configured to pass power from power source 110 to charging circuit 133 and to functional device 120. The discharge circuit 137 is configured to prevent power transfer from energy storage device 135 to functional device 120. Charging circuit 133 modifies the power from power source 110 as necessary to charge energy storage device 135. Generally, energy storage device 135 is a battery, capacitor, inductor, or other device capable of storing energy.

If power source 110 fails, power path control circuit 131 and discharge circuit 137 are configured to allow power to pass from energy storage device 135 to functional device 120 through discharge circuit 137 and power path control circuit 131. Generally, functional device 120 is informed that power is being supplied by backup power system 130 so that appropriate measures can be performed to prevent data loss in functional device 120. For example, if functional device 120 includes volatile memory, the contents of the volatile memory can be written to non-volatile memory such as Flash RAM or disk drives.

In many electronic systems, power source 110 only provides a limited amount of power. For example for some systems, power source 110 is supplied through a standard bus, such as PCI, where a limited amount of power is available to each device. Generally, backup power system 130 draws more power when energy storage device 135 is discharged and gradually draws less power as energy storage device is charged. However, functional device 120 may have other components that also require additional power upon activation. Thus, when electronic system 100 is initially activated, there may be contention between functional device 120 and backup power system 130 for power from power source 110. Hence there is a need for a method and system for controlling the power draw of a charging circuit to prevent power contention with a functional device.

### SUMMARY

Electronic systems often have a limited amount of power available and thus require management of the power of individual subsystems. One functional block often present in electronic systems is a charging system with an energy storage device. Often the charger circuit may have different levels of power available to charge the energy storage device depending on the state of other subsystems of the electronic system. The present invention provides a source power limiting charging system. Often the losses of the charging system and losses due to the power requirements of support systems are not well known and/or are variable. Controlling source power to the charging system maximizes the amount of power delivered to the energy storage device for a given value of these losses and avoids power contention with the other elements of the electronic system.

In accordance with the present invention a power system includes an energy storage device and a power limiting charging circuit. The power limiting charging circuit is configured to draw a limited amount of source power from a power source to charge the energy storage device. Specifically, the power limiting charging circuit receives a power limit parameter that defines a source power limit. Power limited charging circuit draws an amount of source power that is less than the source power limit and provides a charge power to the energy storage device. Some embodiments of the present invention also include a power sensing circuit between the power source and the power limited charging circuit to sense source power information, which may include source current value of a source current or a source voltage value of a source voltage.

The present invention will be more fully understood in view of the following description and drawings.

### BRIEF DESCRIPTION OF THE DRAWINGS

FIG. 1 is a simplified block diagram of an electronic system with a conventional backup power system.

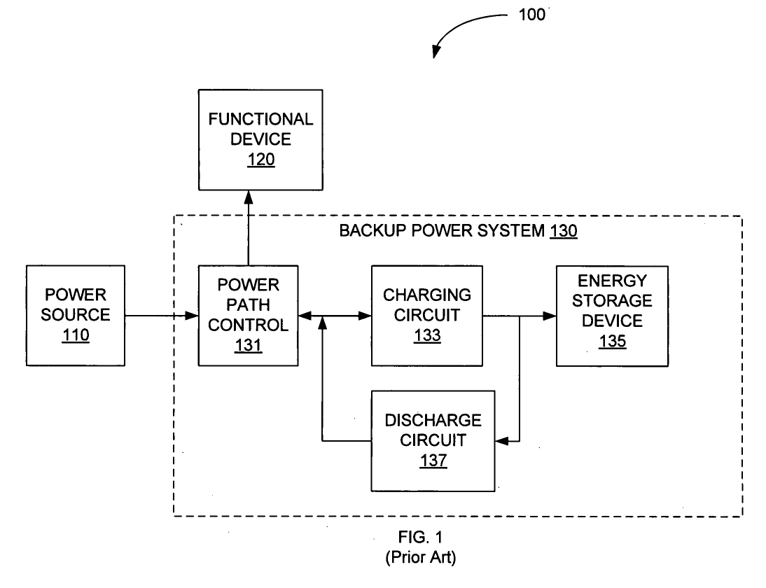

FIG. 2 a simplified block diagram of an electronic system in accordance with one embodiment of the present invention.

FIG. 3 is block diagram of a power sensing circuit in accordance with one embodiment of the present invention.

FIG. 4 is block diagram of a controllable power limiting charging circuit in accordance with one embodiment of the present invention.

FIG. 5 is a flow diagram for a charge control circuit in accordance with one aspect of the present invention.

FIG. 6 is a block diagram of an energy storage device in accordance with one aspect of the present invention.

FIG. 7 a simplified block diagram of an electronic system in accordance with one embodiment of the present invention.

### DETAILED DESCRIPTION

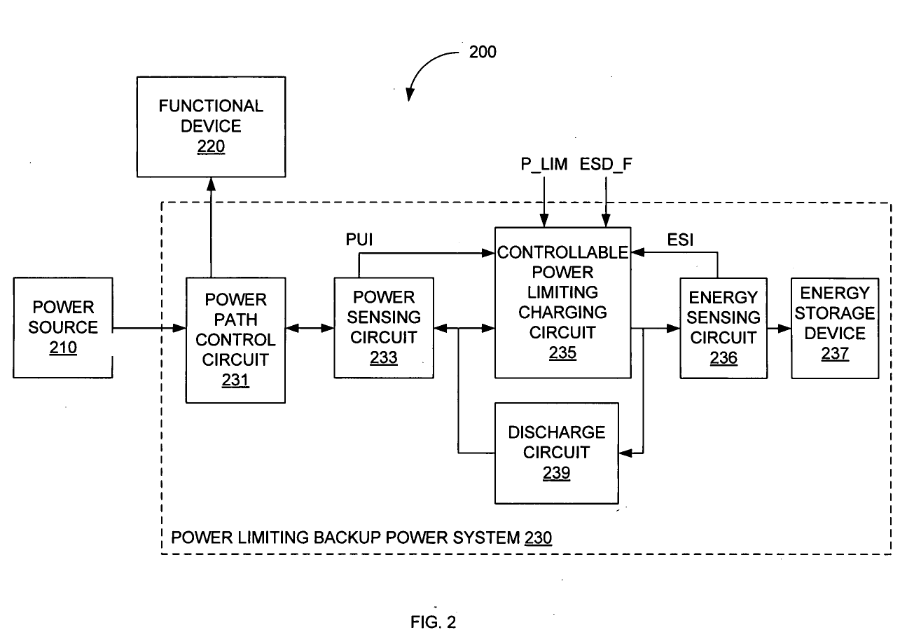

As explained above, backup power systems may have power contention issues with the functional device in an electronic system. However, in accordance with the present invention, a power limiting backup power system makes use of a power limiting charging circuit to limit the amount of power drawn from the power source. Specifically, the amount of power used by a power limiting backup power system can be controlled by a power limit parameter P_LIM. FIG. 2 shows a block diagram of an electronic system 200 that includes a power source 210, a functional device 220, and a power limiting backup power system 230 in accordance with one embodiment of the present invention. Power source 210 provides power to functional device 220 and power limiting backup power system 230. If power source 210 fails, power limiting backup power system 230 provides power to functional device 220. Unlike conventional backup power systems, power limiting backup power system 230 is controlled by a power limit parameter P_LIM. Specifically, power limit parameter P_LIM defines a source power limit. In some embodiments of the present invention, power limit parameter P_LIM is provided by functional device 220. Power limiting backup power system 230 draws no more power than the source power limit as explained below. Furthermore, power limiting backup power system 230 also receives an energy storage device full parameter ESD_F, which is used to determine when to transition from a charging mode to a maintenance mode as described below. Generally, energy storage device full parameter ESD_F should define an amount of energy that allows functional device 220 to shut down without error. Thus, in some embodiments of the present invention, energy storage device full parameter is provided by functional device 220.

Power limiting backup power system 230 includes a power path control circuit 231, a power sensing circuit 233, a controllable power limiting charging circuit 235, an energy sensing circuit 236, an energy storage device 237, and a discharge circuit 239.

When power source 210 is available, power path control circuit 231 is configured to pass power from power source 210 to functional device 220 and pass power from power source 210 to controllable power limiting charging circuit 235 through power sensing circuit 233. Discharge circuit 239 is configured to prevent power transfer through discharge circuit 239. Controllable power limiting charging circuit 235 modifies the power from power source 210 as necessary to charge energy storage device 237. Power sensing circuit 233 measures the power drawn from power source 210 by controllable power limiting charging circuit 235 and provides power usage information PUI to controllable power limiting charging circuit 235. Controllable power limiting charging circuit 235 prevents the power usage from exceeding power limit parameter P_LIM. Generally, controllable power limiting charging circuit 235 can reduce the power usage from power source 210 by reducing charge voltage V_C, charge current I_C, or a combination of charge voltage V_C and charge current I_C.

In some embodiments of the present invention, power sensing circuit 233 may be placed between power source 210 and power path control circuit 231. In these embodiments power sensing circuit can sense the combined power usage of both power limiting backup power system 230 and functional device 220. Furthermore, some embodiments of the present invention may include another power sensing circuit in between power path control circuit 231 and functional device 220 to sense the power usage of functional device 220.

Energy sensing circuit 236 measures the amount of energy stored in energy storage device 237 and provides energy storage information ESI to controllable power limiting charging circuit 235. In one embodiment of the present invention energy sensing circuit 236 includes a current sensor and a voltage sensor.

For clarity, the voltage, current, and power from power source 210 to controllable power limiting charging circuit 235 is referred to as source voltage V_S, source current I_S and source power P_S. Conversely, the voltage, current, and power provided by controllable power limiting charging circuit 235 to energy storage device 237 is referred to as charge voltage V_C, charge current I_C, and charge power P_C.

In some embodiments of the present invention, power usage information PUI includes both the value of source voltage V_S and the value of source current I_S. In other embodiments, power usage information PUI is the value of source power P_C. In still other embodiments of the present invention, the power usage information PUI only includes the value of source current I_S because the value of source voltage is predefined and not variable or can be independently determined by controllable power limiting charging circuit 235. Similarly energy storage information may include different types of information depending on the implementation of energy storage device 237. For example for capacitor based energy storage devices, energy storage information ESI may be the voltage of the energy storage device 237. For other embodiments, energy storage information ESI may be a current measurement or a power measurement. Generally, energy storage information ESI is correlated with energy storage device full parameter ESD_F.

If power source 210 fails, power path control circuit 231 and discharge circuit 239 are configured to pass power from energy storage device 237 to functional device 220. Furthermore, controllable power limiting charging circuit 235 stops charging energy storage device 237. In some embodiments of the present invention energy storage device 237 also powers some or all parts of power limiting backup power system 230 when power source 210 is unavailable.

In some embodiments of the present invention, portions of power limiting backup power system 230 may be included in functional device 220. For example control functions of controllable power limiting charging circuits 235 may be carried out by controllers (such as microprocessors or microcontrollers) on functional device 220.

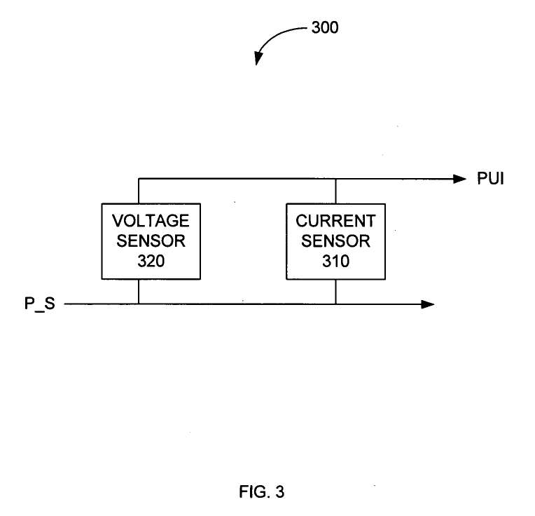

FIG. 3 is a simplified block diagram of a power sensor 300 that can be used as power sensing circuit 233 (FIG. 2). Power sensor 300 includes a current sensor 310 that measures the value of source current I_S and a voltage sensor 320 that measures the value of source voltage V_S. The values measured by current sensor 310 and voltage sensor 320 are provided to controllable power limiting charging circuit 235 as power usage information PUI. Current sensors and voltage sensors are well known in the art. Any of the well known conventional current sensors and voltage sensors can be used with the present invention.

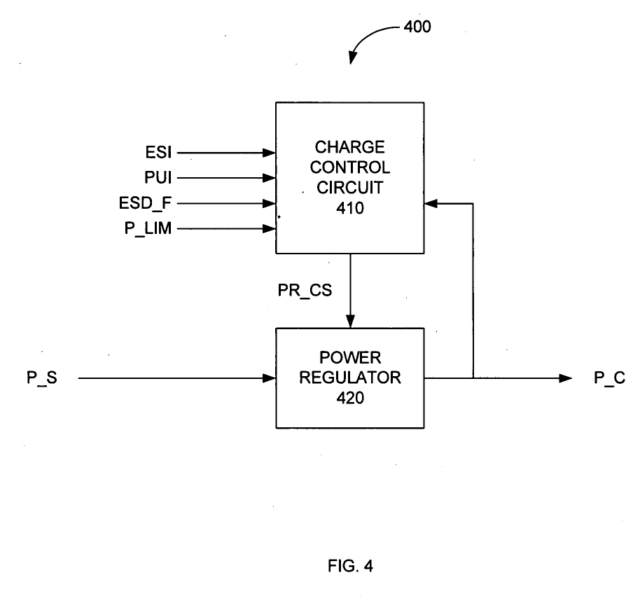

FIG. 4 is a block diagram of a controllable power limiting charging circuit 400 which can be used in place of controllable power limiting charging circuit 235 (FIG. 2). Controllable power limiting charging circuit 400 includes a charge control circuit 410 and a power regulator 420. Charge control circuit 410 receives energy storage information, ESI, power usage information PUI, energy storage device full parameter ESD_F, and power limit P_LIM. Charge control circuit 410 controls the function of power regulator 420 using one or more power regulator control signals PR_CS. Depending on the implementation of power regulator 420, Charge control circuit 410 may use power regulator control signals PR_CS with variable voltage, variable current, or a combination of variable voltages and currents, to control power regulator 420. Charge control circuit 410 can be implemented for example with a microcontroller, discrete circuitry, field-programmable gate arrays, or an application specific integrated circuit. For example, in a specific embodiment of the present invention, charge control circuit 410 is implemented using two microcontrollers (part number ST72F344K4T6) from ST Microelectronics. In some embodiments of the present invention, part or all of charge control circuit 410 can be placed on functional device 220.

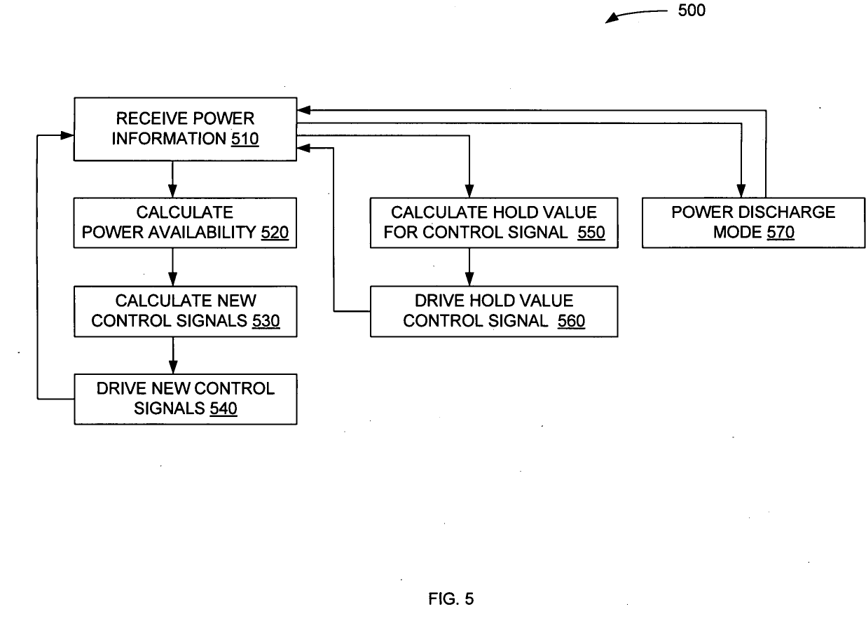

In many embodiments of the present invention, charge control circuit 410 also controls power path control circuit 231 and discharge circuit 239. In a specific embodiment of the present invention, charge control circuit 410 can be powered by power source 210 or energy storage device 237. Specifically, when power source 210 provides greater voltage than energy storage device 237, then power source 210 powers charge control circuit 410. However, when energy storage device 237 provides greater voltage than power source 210, then energy storage device 237 powers control circuit 410. The performance of charge control circuit 410 is described below and shown in FIG. 5.

Power regulator 420 can be implemented using a variety of circuits. For example, power regulator 420 can be an inverting or non-inverting switching regulator such as a SEPIC (single ended primary inductor converter), a buck regulator, a buck-boost regulator, a boost regulator, a flyback regulator, or a linear regulator such as a low dropout regulator or a inverting or non-inverting switched capacitor regulator. Power regulator 420 receives source power P_S (from power source 210 (FIG. 2)) and provides charge power P_C (to energy storage device 237 (FIG. 2)). Charge control circuit 410 controls power regulator 420 with one or more power regulator control signals PR_CS. In a specific embodiment of the present invention, power regulator 420 is an LTC3770 buck regulator manufactured by Linear Technology.

FIG. 5 is a flow diagram 500 for charge control circuit 410. On power up, flow diagram 500 begins at RECEIVE POWER INFORMATION 510 and receives power information such as power limitation parameter P_LIM, power usage information PUI (such as the value of source voltage V_S and the value of source current I_S), energy storage device full parameter ESD_F, energy storage information (such as the value of charge voltage V_C). The values of source voltage V_S and/or source current I_S can be used to determine the state of power source 210. For example if the value of source voltage V_S or source current I_S is zero or below certain thresholds then charge control circuit 410 can determine that power source 210 is not available. For example in one embodiment of the present invention, when the value of source voltage V_S is less than the value of charge voltage V_C as provided by energy storage device 237, then charge control circuit 410 considers power source 210 to be unavailable. If charge control circuit 410 determines that power source 210 is unavailable, charge control circuit 410 transitions to POWER DISCHARGE MODE 570. IN POWER DISCHARGE MODE 570, discharge circuit 239 and power path control circuit 231 are configured to allow energy storage device 237 to supply power to functional device 220. Furthermore, in some embodiments of the present invention, energy storage device 237 also provides power to some or all parts of power limiting backup power system 230. When power source 210 becomes available, charge control circuit 410 returns to RECEIVE POWER INFORMATION 510.

While in RECEIVE POWER INFORMATION 510, when charge control circuit 410 determines that the power source 210 is available, charge control circuit 410 also determines whether energy storage device 237 is full. In accordance with one embodiment of the present invention, energy storage device full parameter ESD_F is a voltage parameter. Energy storage device 237 is considered full if the voltage of energy storage device 237 is equal to or greater than energy storage device full parameter ESD_F.

If power source 210 is available and energy storage device 237 is not full, then charge control circuit 410 transitions to CALCULATE POWER AVAILABILITY 520 and calculates a power availability value P_AV, which is equal to the source power limit (as defined by power limit parameter P_LIM) minus the amount of power currently being drawn from power source 210, which is provided by or can be calculated from power usage information PUI. Then, charge control circuit 410 transitions to CALCULATE NEW CONTROL SIGNALS 530.

In CALCULATE NEW CONTROL SIGNALS 530, charge control circuit 410 calculates new values for power regulator control signal(s) PR_CS. In some embodiments of the present invention, the new values for power regulator control signal(s) are calculated so as to reduce the magnitude of power availability value P_AV to zero. In other embodiments of the present invention a more iterative approach is used so that the new values for power regulator control signal(s) reduces the magnitude of power availability value P_AV by some amount each iteration.

Then, in DRIVE NEW CONTROL SIGNALS 540, charge control circuit 410 drives power regulator control signal(s) PR_CS to the new values. After which, charge control circuit 410 transitions back to RECEIVE POWER INFORMATION 510.

In RECEIVE POWER INFORMATION 510, if charge control circuit 410 detects that power source 210 is available and that energy storage device 237 is full, charge control circuit 410 transitions to CALCULATE HOLD CONTROL SIGNAL 550. In CALCULATE HOLD CONTROL SIGNAL 550, charge control circuit 410 calculates hold values for power regulator control signal(s) PR_CS so that the energy in energy storage device 237 is maintained. The hold values to maintain charge in energy storage device 237 depends on the implementation of energy storage device 237. For example, if energy storage device 237 is a battery, charge control circuit 410 would configure power regulator 420 to provide a trickle charge or a float voltage to energy storage device 237. If energy storage device 237 is formed using capacitors, charge control circuit 410 would configure power regulator 420 to maintain the voltage in energy storage device 237 or provide a small current to compensate for leakage in the capacitors. Then, control circuit 410 drives the hold values on power regulator control signal(s) PR_CS in DRIVE HOLD CONTROL SIGNAL 560. Charge control circuit 410 then transitions to RECEIVE POWER INFORMATION 510.

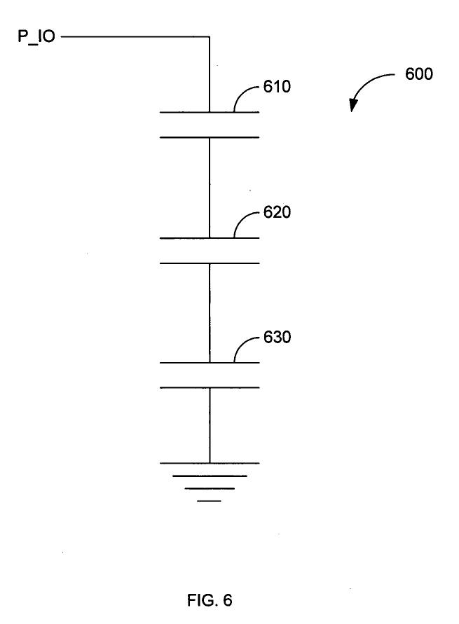

FIG. 6 is a block diagram of a energy storage device 600 which can be used in place of energy storage device 237. Energy storage device 600 includes capacitors 610, 620, and 630 coupled in series between power input output terminal P_IO and ground. In a specific embodiment of the present invention capacitors 610, 620, and 630 are manufactured by Cooper Bussman and have a part number of B1860-2R5107-R.

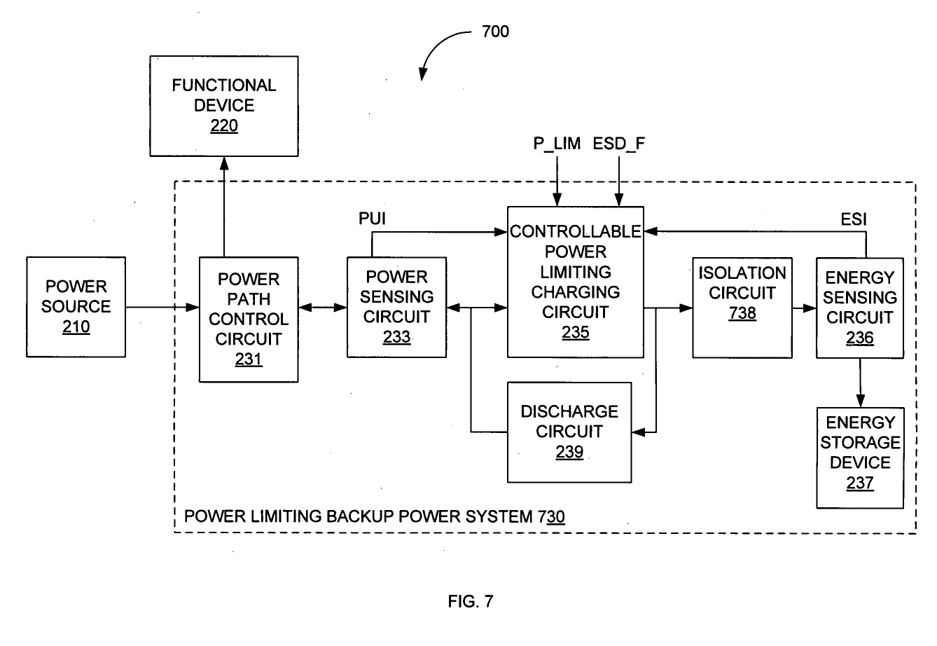

FIG. 7 shows a block diagram of an electronic system 700. Because electronic system 700 is very similar to electronic system 200 (FIG. 2), the same reference numerals are used for identical elements. For brevity, the description of identical elements is not repeated. Electronic system 700 includes a power source 210, a functional device 220, and a power limiting backup power system 730. Power limiting backup power system 730 differs from power limiting backup power system 230 (FIG. 2) by including an isolation circuit 738 between controllable power limiting charging circuit 235 and energy sensing circuit 236. For certain types of energy storage devices, and/or power regulators, the power regulator is not capable of initializing while connected to the energy storage device 237. Thus, isolation circuit 738 is activated to isolate energy storage device 237 from controllable power limiting charging circuit 235. After energy sensing information ESI is received by controllable power limiting charging circuit 235, power regulator 420 is initialized to match certain conditions (such as the voltage) of energy storage device 237. Then isolation circuit 738 is deactivated which recouples energy storage device 237 to controllable power limiting charging circuit 235.

In the various embodiments of the present invention, novel methods and systems have been described for charging a energy storage device with a controllable power usage of the power source. By limiting the power drawn from the power source, contention between a functional device and a backup power system can be greatly reduced. The various embodiments of the structures and methods of this invention that are described above are illustrative only of the principles of this invention and are not intended to limit the scope of the invention to the particular embodiments described. For example, in view of this disclosure those skilled in the art can define other energy storage devices, switches, power sensing circuits, controllable power limiting charging circuits, charge control circuits, and so forth, and use these alternative features to create a method, or system according to the principles of this invention. Thus, the invention is limited only by the following claims.

What is claimed is:

1. A power system coupled to receive power from a power source, the power system comprising:
an energy storage device; and
a power limiting charging circuit coupled to charge the energy storage device and configured to draw a limited amount of source power from the power source.

2. The power system of claim 1, further comprising a power sensing circuit coupled between the power limiting charging circuit and the power source.

3. The power system of claim 2, wherein the power sensing circuit is configured to sense source power usage information of the power from the power source.

4. The power system of claim 3, wherein the power sensing circuit comprises a current sensor.

5. The power system of claim 4, wherein the power usage information includes a source current value of source current from the power source.

6. The power system of claim 3, where the power sensing circuit comprises a voltage sensor.

7. The power system of claim 6, wherein the power usage information includes a source voltage value of a source voltage of the power source.

8. The power system of claim 1, wherein the power limiting charging circuit varies a charge current to energy storage device to limit the amount of source power drawn from the power source.

9. The power system of claim 1, wherein the power limiting charging circuit varies a charge voltage to the energy storage device to limit the amount of source power drawn from the power source.

10. The power system of claim 1, wherein the power limiting charging circuit receives and is configured by a power limit parameter.

11. The power system of claim 10, wherein the power limit parameter defines a source power limit and wherein the source power drawn from the power source is less than the source power limit.

12. The power system of claim 1, wherein the power limiting charging circuit further comprises:
a power regulator coupled to receive source power from the power source and coupled to provide a charge power to the energy storage device; and
a charge control circuit coupled to control the power regulator.

13. The power system of claim 12, wherein the charge control circuit controls the power regulator using one or more power regulator control signals.

14. The power system of claim 13, wherein the charge control circuit varies a voltage level of a power regulator control signal to control the power regulator.

15. The power system of claim 13, wherein the charge control circuit varies a current level of a power regulator control signal to control the power regulator.

16. The power system of claim 12, wherein the power regulator is a buck regulator.

17. The power system of claim 1, wherein the energy storage device comprises a first capacitor.

18. The power system of claim 17, wherein the energy storage device further comprises a second capacitor coupled in series with the first capacitor.

19. The power system of claim 18, wherein the energy storage device further comprises a third capacitor coupled in series with the first capacitor and the second capacitor.

20. A method to charge an energy storage device from a power source, the method comprising:
receiving a power limit parameter with a power limiting charging circuit, wherein the power limit parameter defines a source power limit;
limiting an amount of source power drawn from the power source with a power limiting charging circuit, wherein the amount of source power from the power source is less than the source power limit; and
providing a charge power to the energy storage device.

21. The method of claim 20, further comprising sensing source power information.

22. The method of claim 21, wherein the source power information includes a source current value for a source current.

23. The method of claim 21, wherein the source power information includes a source voltage value for a source voltage

24. The method of claim 21, further comprising adjusting the charge power so that the amount of source power is less than the source power limit.

25. The method of claim 21 further comprising calculating a power availability value.

26. The method of claim 25, wherein the power availability value is equal to the source power limit minus the amount of source power drawn from the power source by the power limiting charging circuit.

27. The method of claim 25, further comprising calculating values for one or more control signals to reduce the magnitude of the power availability value.

28. The method of claim 27, wherein the adjusting the charge power so that the amount of source power is less than the source power limit further comprises controlling a power regulator with the control signals.

29. The method of claim 28, wherein the power regulator comprises a buck regulator.
